(19) United States
(12) Patent Application Publication
(10) Pub. No.: US 2026/0219021 A1
(43) Pub. Date: Jul. 30, 2026

(54) SENSOR AND METHOD FOR MEASURING A PHYSICAL VARIABLE OF A PLANAR MEDIUM

(71) Applicant: MICRO-EPSILON-MESSTECHNIK GMBH & CO. K.G., Ortenburg (DE)

(72) Inventors: Michael Kuran, Fürstenzell (DE); Norbert Reindl, Fürstenzell (DE); Thomas Haslinger, Ortenburg (DE); Thomas Wisspeintner, Ortenburg (DE)

(21) Appl. No.: 19/143,684

(22) PCT Filed: Dec. 27, 2023
(86) PCT No.: PCT/DE2023/200268

§ 371 Date: Jun. 26, 2025

(30) Foreign Application Priority Data
Dec. 30, 2022 (DE) 10 2022 214 457.0

(51) Int. Cl. G01B 7/06; G01B 11/06; G01D 5/20; G01D 5/24

(52) U.S. Cl. CPC G01B 7/085; G01B 7/105; G01B 11/0616; G01D 5/20; G01D 5/24

(57) ABSTRACT

The invention relates to a sensor for measuring a physical variable of a planar medium on a carrier (5), wherein the sensor comprises two different measuring devices (2, 3) in order to carry out measurements on the basis of at least two different physical measurement principles, wherein the first measuring device (2) comprises an inductive or eddy-current sensor and the second measuring device (3) comprises a capacitive or optical sensor, wherein the first measuring device (2) is influenced predominantly or exclusively due to an electromagnetic effect, which can be induced or can arise in the carrier (5) of the planar medium during the measurement, and the second measuring device (3) is influenced predominantly or exclusively by the planar medium, wherein the measurement signal of the second measuring device (3) relative to the measurement signal of the first measuring device (2) results in the measurement signal of the physical variable of the planar medium. With a view to particularly reliable measurement of the physical variable of a planar material with structurally simple means, said sensor is designed and developed such that the first measuring device (2) is selected and/or can be operated such that the electromagnetic effect can be induced or can arise exclusively or predominantly in a definable layer, which is as thin as possible, on a surface of the carrier (5). The invention also relates to a corresponding method.

### CROSS REFERENCE TO RELATED APPLICATIONS

This application is a National Stage Application, filed under 35 U.S.C. § 371, of International Application No. PCT/DE2023/200268, filed Dec. 27, 2023, which international application claims priority to and the benefit of German Application No. 10 2022 214 457.0, filed Dec. 30, 2022; the contents of both of which as are hereby incorporated by reference in their entireties.

### BACKGROUND

### Technical Field

The invention relates to a sensor for measuring a physical variable of a planar medium on a carrier, wherein the sensor has two different measuring devices for performing measurements based on at least two different physical measuring principles, wherein the first measuring device has an inductive or eddy current sensor and the second measuring device has a capacitive or optical sensor, wherein the first measuring device is influenced predominantly or exclusively by an electromagnetic effect which can be induced or arise in the carrier of the planar medium during the measurement, and the second measuring device is influenced predominantly or exclusively by the planar medium, wherein the measurement signal of the second measuring device, in relation to the measurement signal of the first measuring device, yields the measurement signal of the physical variable of the planar medium.

Furthermore, the invention relates to a method for measuring a physical variable of a planar medium on a carrier with such a sensor, wherein the sensor has two different measuring devices for performing measurements based on at least two different physical measuring principles, wherein the first measuring device has an inductive or eddy current sensor and the second measuring device has a capacitive or optical sensor, wherein the first measuring device is influenced predominantly or exclusively by an electromagnetic effect which can be induced or arise in the carrier of the planar medium during the measurement, and the second measuring device is predominantly or exclusively influenced by the planar medium, wherein the measurement signal of the second measuring device, in relation to the measurement signal of the first measuring device, yields the measurement signal of the physical variable of the planar medium.

The electromagnetic effect which predominantly or exclusively influences the first measuring device is a desired useful effect or measuring effect on the basis of which the inductive or eddy current sensor operates and from which a measuring signal such as a distance value is obtained. In contrast thereto, it is possible during measuring for undesired interference effects to occur, in particular also undesired electromagnetic interference effects. In this respect, an electromagnetic effect detected by the sensor can have both a desired and an undesired component.

### DESCRIPTION OF RELATED ART

When producing strip materials or films, it is very important, among other things, to measure the thickness in order to ensure the essential properties of the material, for example. Materials of this type can very often also be coated, for example in a conductive, semi-conductive or insulating manner, as is, for example, very often the case in the field of battery production.

If it is possible to perform a measurement on two sides, it is possible to use, for example, optical, inductive or capacitive sensors which could be mounted on a bracket or frame and from both sides measure the films that are to be inspected.

The sensors are used in a fixed or traversing configuration.

However, many users wish to be able to measure the thickness of films on one side. In addition, limited installation space, ambient temperatures and other factors restrict the use of sensor technology used to date.

One-sided measuring is used to determine different physical variables, such as for example the thickness but also the density. Radioactive surface radiators are often used for such applications, with the weight per unit area providing the basis for calculating the thickness.

Problems in the case of one-sided measuring with radio-metric systems are that: radiation officers are required, the measurements are often very inaccurate, and numerous safety precautions must be taken during operation.

In the field of battery film production in particular, the films are usually non-transparent, which further limits the choice of possible sensor technology; for example, optical measuring sensors can only be used to a limited extent.

The temperatures of well over 100° C. that are common in many applications also significantly limit the available options. Sensors with integrated electronics in particular cannot be used in this hot environment, or only with a great deal of effort to provide cooling.

For insulating films, a combination sensor consisting of inductive and capacitive or optical sensors, for example, has been used successfully in the industry for many years.

The films to be measured usually run on a metal roller, for example aluminum or steel. These rollers require a very long service life. This means that steel rollers are usually used in the case of abrasive media, the steel rollers very often being coated with resistant layers to ensure a long service life despite these abrasive media. Measuring with inductive sensors often leads to incorrect measurements, since these steel rollers are ferromagnetic and cause corresponding measurement errors in the sensors. This is referred to as the so-called run-out effect, which is based on the Weiß domains and is described in more detail below.

Sensors that measure the media thickness using the shadowing principle are independent of these factors and can also measure non-transparent media very well. However, this method also detects wobbling motions of the carrier roller. This wobbling motion can only be partially compensated for by mounting another sensor at the edge of the roller in an area without strip material and using this detected wobbling motion as a basis for the sensor measuring the thickness. However, this implies that the wobble motion is comparable at all points, which cannot be guaranteed in reality, for example in the middle of a roller.

### BRIEF SUMMARY

In general, the present invention deals with eliminating or at least reducing the run-out effect when measuring properties such as thickness, density, weight per unit area, conductivity, etc. of, for example, strip materials that are guided over rollers. A run-out effect occurs when interference occurs in the measurement signal due to the rotational movement of, for example, a roller, which are either repeatable—reproducible with the rotational speed of the roller (repeatable run-out)—or non-repeatable (non-repeatable run-out). A run-out effect is an interference effect that has a negative impact on a desired effect, namely a measurement effect.

There are generally several causes for such a run-out effect;

3. In general, rollers have a certain amount of radial run-out, also known as concentricity or mechanical run-out. This results from inaccuracies in the diameter of the roller, tolerances in the bearing, or other mechanical causes. These cause the distance to change reproducibly or also non-reproducibly when measuring a distance against the surface of the roller while the roller is rotating. Reproducible impact results from systematic errors in the bearings, on the surface, etc., which are repeated with every rotation. Non-reproducible impact is caused by random errors, which are usually the result of excessive play in the bearing and tend to occur relatively rarely.

4. Electrical run-out can occur when measuring against roller surfaces with inductive or eddy current sensors. This does not depend on the mechanical (geometric) properties of the roller's concentricity, but on the electrical or magnetic properties of the roller material. An electrical property is, for example, conductivity σ or its reciprocal, specific resistance p. A magnetic property is, for example, magnetic permeability μᵣ. The cause of this type of run-out effect in the case of ferromagnetic materials is, for example, the Weiss domains which influence inductive or magnetic measurements by changing the magnetization and thus μᵣ in magnitude and/or direction within the material, meaning that the material is not homogeneous. Another cause can be micro-cracks in the roller surface, which locally influence the conductivity and thus mainly affect the eddy currents. These effects overlap in ferromagnetic materials and occur to varying degrees depending on the sensor type. Often, the causes cannot be precisely separated when measurements are taken with sensors that contain a coil (inductive, eddy current). It is only possible to recognize a change in the signal which does not result from the change in distance but overlaps the distance signal due to electrical run-out.

During measuring the thickness of media that are guided over a roller, these errors caused by the mechanical (point 1.) and the electrical (point 2.) must be compensated. This depends on which properties the medium has and which measurement method is to be used.

In order to compensate for the mechanical run-out effect, a method using combined measuring principles, known as “combination sensors,” is known. A first sensor detects the properties of the measurement object, a second sensor which is ideally not influenced itself by the measurement object detects the surface of the roller. It is possible to determine the thickness of the strip material from the difference between the two signals, for example. However, it is also possible to determine other measurement variables, such as the density, or the so-called weight per unit area or also the conductivity of the strip material, using appropriate sensors.

In the case of non-metal measurement objects, an inductive or eddy current sensor is used as the first sensor. This is not influenced by the measurement object and detects the radial run-out of the roller by detecting the surface of the roller through the measurement object. A second sensor using, for example, a capacitive or optical measuring principle detects the measurement object, for example its surface, or the surface density. Ideally, the sensors used are arranged in a concentric manner so that the measurement location is the same for both and no additional possible errors in the case of any misalignment, for example tipping errors, occur. It is then possible to determine the thickness very precisely from the difference, wherein the mechanical run-out effect is effectively compensated by the use of the two different measuring principles.

In the case of metal measurement objects which would prevent measurements through the material using inductive or eddy current sensors, these sensors can be arranged at the side adjacent to the strip material. However, this has the disadvantage that the measurement location does not correspond to the second sensor, which may require additional compensation measures.

Note: Conductive materials can also be measured with inductive or eddy current sensors if the material is sufficiently thin or the conductivity is very low. A superimposed signal is then obtained from the measurement object and the roller. If different operating frequencies are used for the first sensor and the second sensor, it is possible, among other things, to separate the measurement signals of the roller and the measurement object, wherein it is possible to measure the properties of the measurement object.

However, in this case the inductive or eddy current sensor-first sensor—can be influenced by the roller material, which leads to an electrical run-out and consequently to errors when measuring the thickness. Unfortunately, an inductive or eddy current sensor does not provide ideal detection of only the surface of the roller, but has a certain volume effect. This is where the penetration depth δ comes into play, which depends, among other things, on the material in question (σ, μᵣ) and the operating frequency (oscillator frequency) ω=2πf of the sensor:

$$δ ∝ \sqrt{\frac{1}{f * σ * {μ}_{r}}} .$$

The penetration depth indicates the depth within which the current density which is induced in a conductor due to an electromagnetic wave has dropped to the value 1/e. Usually, three times the value of the penetration depth is used as the depth where effects of the current density are negligible on measurements.

The object of the present invention is therefore to propose a sensor and a method of the type mentioned at the beginning, whereby it is possible to obtain a particularly reliable measurement of the physical variable of a planar material using constructively simple means.

In accordance with the invention, the abovementioned object is achieved on the one hand by a sensor with the features of appended sensor claim. Accordingly, the sensor is configured and developed in such a manner that the first measuring device is selected and/or can be operated in such a manner that the electromagnetic effect can be induced or arise exclusively or predominantly in a thinnest possible definable layer on one surface of the carrier.

In a manner in accordance with the invention, it is initially recognized that, by skillfully selecting the measuring devices used in the sensor, the above object is achieved in a surprisingly simple manner. In this case, in a further manner in accordance with the invention, the first measuring device is selected and/or can be operated in such a manner that interference in a measurement signal from greater depths in the volume of the carrier is reduced as far as possible or completely avoided. For this purpose, the first measuring device is specifically selected or can be operated in such a manner that the electromagnetic effect—the desired component of the electromagnetic effect—can be induced or arise exclusively or predominantly in a thinnest possible definable layer on one surface of the carrier.

In a particularly reliable manner, an operating frequency of the first measuring device can be selected in the specific case in such a manner that the desired electromagnetic effect can be induced or arise exclusively or predominantly in the thinnest possible definable layer on the surface of the carrier. The selectability of the operating frequency is simple to implement in terms of design.

Furthermore, with regard to a particularly reliable measurement, the layer can be formed by coating the carrier in such a manner that the desired electromagnetic effect can be induced or arise. In this case, it is possible, in turn, in a simple manner to select an operating frequency of the first measuring device in such a manner that the desired electromagnetic effect can be induced or arise exclusively or predominantly in the coating of the carrier. In this case, use is made of the fact that depending upon the selected frequency the electromagnetic effect is induced to a different depth in a substance, by way of example in the carrier. The higher the frequency, the less deep the induction effect reaches into the coating or into the carrier. Since the coating material is selected so that the undesirable magnetic effect cannot be induced or cannot arise in the coating to the same extent as in an uncoated carrier, this embodiment of the method—with a skillful choice of frequency—ultimately achieves the avoidance, significant reduction, or compensation of the undesirable magnetic effect.

In a particularly simple manner, a conductive but not ferromagnetic material, chrome or tungsten carbide can be used as a coating or coating component. These are common coating materials that on the one hand are very robust and on the other hand do not exhibit the magnetic effect, or exhibit it to a lesser extent than conventional carrier materials.

With regard to the implementation of a further physical measuring principle, a measuring device in the form of a temperature measuring device can also be used. A temperature value determined using such a measuring device can be used in a simple manner to increase the accuracy of a measured value when measuring a physical variable of the planar medium.

In a further advantageous manner, the sensor can be designed to detect a rotation or part of a rotation of a rotatable carrier for the medium by means of at least two of the implemented measuring devices. Such detection can be automated in a particularly advantageous manner. A repeating profile of the rotatable carrier, for example a roller, can be used for this purpose. The sensor can be arranged in a constant axial position, i.e. without any traversing movement relative to the carrier. This allows the carrier, for example a roller, to be characterized without the use of an encoder.

In this context, and also in principle, detection can be carried out in a particularly simple and reliable manner on the basis of singularities of the carrier and/or a distance between singularities of the carrier. Such singularities or individual characteristics, irregularities or unevenness, for example defects or manufacturing errors, of the carrier can lead to significant signal shapes that in any case are dependent on the angle of rotation, for example peaks, sequences of peaks, etc. in the signal.

In a specific exemplary embodiment, the planar medium can comprise a strip material or a film. Such a medium is used in various, particularly industrial, areas, and its exact properties, especially geometric properties such as thickness or density, are of great importance.

In specific applications, the physical variable can be the thickness or density of the medium. These variables are of great importance in film production, for example, in order to ensure uniform thickness or density of a medium present in the form of a film.

Furthermore, the above object is achieved by a method with the features of the appended method claim, wherein the method of the type mentioned at the beginning is designed and developed in such a manner that the first measuring device is selected and/or operated in such a manner that the electromagnetic effect can be induced or arise exclusively or predominantly in a thinnest possible definable layer on a surface of the carrier. With regard to the advantages achieved by the method, reference is made to the advantages previously described for the associated sensor in order to avoid repetition and for the sake of simplicity.

In order to achieve on the one hand a particularly safe and on the other hand particularly simple measurement of the physical variable, the sensor and/or the at least two different measuring devices of the sensor can be designed in such a manner that the measurement of the physical variable can be carried out from only one side of the planar medium. Such a one-sided measurement is particularly advantageous in confined spaces, since in so doing a measuring setup usually does not require as much space as a two-sided measurement.

In an advantageous manner, at least a section of the carrier can be measured with regard to the magnetic effect by means of appropriate measuring means before measuring the physical variable of the medium, and a measurement result recorded by means of the measuring means can be used before, after, and/or during a measurement of the physical variable of the medium to compensate for or reduce the influence of the magnetic effect on the measurement. This enables a particularly reliable measurement of the physical variable. In the best case, an entire surface of the carrier is measured, or at least the part of the surface that carries the medium or on which the medium is placed during a measurement. Based on the measurement result obtained in this manner or the measured values determined in this manner, compensation or reduction of the influence of the magnetic effect on the measurement can be carried out, whereby the measurement result or the measured values can be used before, after, and/or during a measurement of the physical variable of the medium. This enables a particularly reliable and simple measurement of the physical variable.

With respect to a particularly reliable measurement of the physical variable, the measuring means can determine by means of a capacitive and inductive measurement from a measuring position a distance between the measuring means or a definable starting point and the carrier along the section or along the entire surface of the carrier, whereby a difference between a distance value recorded with the capacitive measurement and a distance value recorded with the inductive measurement can be determined at at least one defined or at all measuring locations in the section or on the surface. Depending on the local properties of the carrier, a location-dependent difference signal between the capacitive and inductive measurements is obtained. This difference or difference signal can be determined for the entire surface of the carrier or for a relevant section of the surface. A relevant section of the surface can be a section which carries the medium or on which the medium is placed. As a result, the magnetic effect can be reduced or compensated.

In a further advantageous manner, the section or the entire surface of the carrier can each be measured at different temperatures. This allows any possible temperature dependence of the measurement result to be compensated or reduced.

For convenience and to ensure particularly reliable measurement of the physical variable, the recorded measurement results, the recorded distance values, and/or the determined difference or differences can be stored in a characteristic map. This allows the carrier to be characterized using a multidimensional characteristic map, which enables active compensation or reduction of the magnetic effect during measurement, even at different temperatures.

Consequently, the sensor in accordance with the invention and method in accordance with the invention provide a sensor and a method that enable a particularly reliable measurement of the physical variable of a planar material using simple design means.

An exemplary embodiment of the sensor in accordance with the invention can be realized as a combination sensor with a high-frequency eddy current sensor-a combination system for conductive media.

Furthermore, in the case of exemplary embodiments of the sensor in accordance with the invention and methods in accordance with the invention, a run-out effect based on Weiß domains can be taken into account.

In the case of exemplary embodiments of the present invention, it is possible to select for the inductive or eddy current measurement an operating frequency f of the sensor so that the inductive or eddy current effect (=measurement effect) occurs in a very thin layer D≈3*δ on the surface of the roller. This can greatly reduce the volume effect on the measurement signal. In principle, the operating frequency (oscillator frequency) of the sensor is increased so that the penetration depth into the roller material or carrier material is so small that the inductive or eddy current effect only occurs in a thin layer immediately at the surface. Interference in the measurement signal from greater depths can thus no longer occur, or can only occur to a greatly reduced extent.

This is particularly advantageous if the carrier or roller, which is usually made of (ferromagnetic) steel for strength reasons, is coated with a homogeneous surface layer of another electrically conductive material. In this case, the measurement signal is essentially influenced by the properties of the layer and not by the underlying roller material. It is particularly advantageous if the surface layer consists of conductive but non-ferromagnetic material, as this eliminates the magnetic effects (Weiß domains!) in the surface layer. If the oscillator frequency of the sensor is appropriately selected, the electromagnetic effect or measurement effect occurs predominantly or exclusively in the surface layer.

A first sensor is usually an inductive or eddy current sensor, and a second sensor can be a capacitive sensor or an optical distance sensor (triangulation, also laser triangulation, laser profile sensor, confocal chromatic sensor, interferometer, etc.), or a profile sensor that detects the height of the strip material on the carrier or roller by shadowing.

In addition to the possible interference effects and their treatment in the context of exemplary embodiments of the present invention, the following is also stated: interference effects, which include not only the magnetic effects due to the Weiß domains already discussed, but also electrical effects due to (micro) cracks that influence the eddy currents, initially occur in the material of the carrier or, for example, a roller, and have a negative influence on the measurement. The aim is to suppress these interference effects. This is achieved by increasing the operating frequency of the eddy current sensor. As a result, the measurement effects only occur in a thin layer on the surface of the carrier or roller (reduced penetration depth). However, this also means that interference effects are reduced because the influence from the depth of the material is reduced. It is also advantageous to apply a non-ferromagnetic coating to the carrier or roller. It is particularly advantageous if the frequency is adapted to the coating or vice versa, so that the measurement effect occurs predominantly or exclusively in the coating. In the case of a non-ferromagnetic coating, magnetic interference effects are then eliminated and interference from micro-cracks is also reduced if the coating material is selected appropriately.

### BRIEF DESCRIPTION OF THE FIGURES

There are now various possibilities for advantageously designing and developing the doctrine of the present invention. Reference should be made to the subordinate claims on the one hand and to the description below of preferred exemplary embodiments of the sensor in accordance with the invention and methods in accordance with the invention on the other. In conjunction with the description of the preferred exemplary embodiments based on the drawings, generally preferred designs and developments of the doctrine are also explained. In the drawing:

FIG. 1 shows in a perspective representation, schematically, an exemplary embodiment of a measurement setup with a sensor in accordance with the invention and a diagram of generated different signals and

FIG. 2 shows in a perspective representation, schematically, an exemplary embodiment of a measurement setup with a sensor in accordance with the invention and a diagram of a skin depth in dependence upon the operating frequency of an inductive sensor.

### DETAILED DESCRIPTION OF VARIOUS EMBODIMENTS

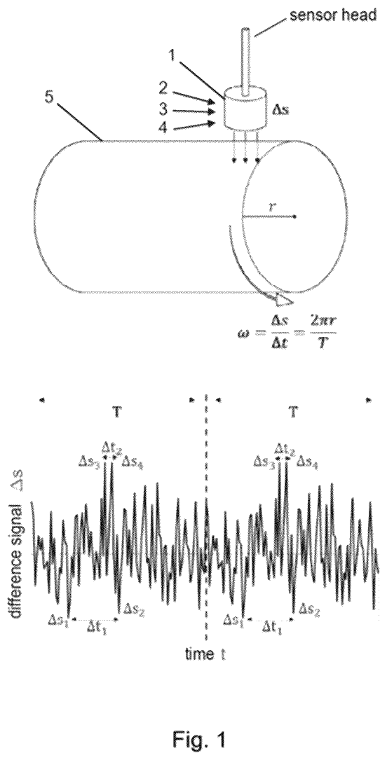

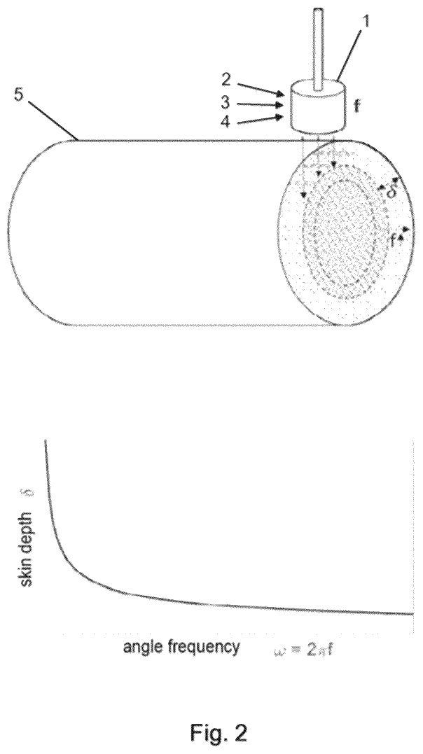

Each of the exemplary embodiments shown in FIGS. 1 and 2 show a sensor with a sensor head 1 which has an inductive measuring device 2, a capacitive measuring device 3 and a temperature measuring device 4. A medium that is to be measured with respect to its thickness, for example, can be placed on a carrier 5 in the form of a roller 5. For the sake of clarity, medium is not placed on the carrier 5 or the roller 5 in the exemplary embodiments shown here.

Based on this combination sensor which combines multiple physical measuring principles, the function principle is expanded to the extent that, for example, the thickness of a semi-conductive film can be measured reliably. In addition, the process temperature can also be detected via a temperature sensor integrated in the combination sensor and output.

In the case of the exemplary embodiments shown here, the physical measuring principles capacitive and inductive or eddy current principle and additionally temperature measuring by means of the temperature measuring device 4 are used.

The design of the structure and functionality of the sensor enable a thickness measurement with compensation or significant reduction of run-out effects of a ferromagnetic roller, as described below.

The integrated temperature sensor or the integrated temperature measuring device 4 as a third measuring element can provide the decisive data for appropriate compensation or reduction in temperature-variable ambient conditions.

The Weiß domain and consequently the run-out effect are distributed unevenly across the material of the roller 5 and also change with the temperature. This results in two independent variables influencing the measurement result of the sensor. This makes compensation very complicated. The integrated temperature sensor or the integrated temperature measuring device 4 can be used to eliminate one of the two interference variables as effectively as possible. To do this, the inductive sensor must be calibrated within the expected temperature range. The properties that change with the temperature are recorded at different intervals that remain constant during the temperature change and stored in the controller as a characteristic curve for the compensation calculation. This type of temperature compensation is already common in many inductive sensors.

When using the sensor or combination sensor with roller 5, encoders or similar measuring means can be used to measure the entire roller without any strip material placed on it. While the capacitive sensor 3 detects the distance to the roller surface, the inductive sensor 2 measures a distance value that is influenced by undesired electromagnetic effects. The magnetic effects cause deviations which enable the roller 5 to be characterized and which represent the second influencing variable. Depending on the local conditions, a difference signal between the capacitive and inductive sensors is generated, see FIG. 1. This difference can be recorded across the entire roller surface and stored in a controller unit as a characteristic map for subsequent compensation calculations. The only important thing here is that the position of roller 5 can be recorded reproducibly and as a result the local compensation calculated live.

Preferably, the compensation of the two influencing variables can also be combined, i.e., the roller 5 can be characterized at different temperatures and a multidimensional characteristic map can be generated, which can be used for active compensation during operation.

In addition to recording the roller revolutions using an encoder or similar device, the innovative combination sensor system also enables a so-called fingerprint to be recorded via automatic revolution detection—recurring profile/characteristic curve analysis—in a constant axial position of the sensor during one revolution—i.e., not traversing—and a compensation characteristic curve to be calculated based on this. For example, intelligent evaluation can detect significant recurring singularities and use them for automatic rotation detection. The singularities and their distances from each other enable the characterization of the roller 5 without the use of an encoder.

In a second variant, the run-out effect of the carrier roller 5 is avoided from the outset by matching and calibrating the inductive sensor of the combination system to a coated roller 5 in such a way that the eddy currents resulting from the measuring principle flow exclusively in a defined layer or coating with a reduced run-out effect. Here, for example, a combination of homogeneous coating and matching operating frequencies f of the inductive sensor ensures that the magnetic effect or eddy currents flow or are formed exclusively or essentially in the coating, taking into account the skin effect. The skin effect means that eddy currents only flow in the coating and are little or not at all affected by interference. Depending on the carrier frequency, this can be achieved, for example, by a 100 μm thick chrome layer or other mechanically resistant layers such as tungsten carbide, etc. This reduces or even minimizes the need for compensation. FIG. 2 shows a diagram of the dependence of the skin depth on the oscillator frequency or operating frequency of the inductive sensor.

This combination of different measuring principles allows the thickness of media to be measured reliably in both cold and high-temperature processes.

In a manner in accordance with the invention, it is initially recognized that, by skillfully selecting the measuring devices used in the sensor, the above object is achieved in a surprisingly simple manner. In this case, in a further manner in accordance with the invention, the first measuring device is selected and/or can be operated in such a manner that interference in a measurement signal from greater depths in the volume of the carrier is reduced as far as possible or completely avoided. For this purpose, the first measuring device is specifically selected or can be operated in such a manner that the electromagnetic effect—the desired component of the electromagnetic effect—can be induced or arise exclusively or predominantly in a thinnest possible definable layer on one surface of the carrier.

In a particularly reliable manner, an operating frequency of the first measuring device can be selected in the specific case in such a manner that the desired electromagnetic effect can be induced or arise exclusively or predominantly in the thinnest possible definable layer on the surface of the carrier. The selectability of the operating frequency is simple to implement in terms of design.

Furthermore, with regard to a particularly reliable measurement, the layer can be formed by coating the carrier in such a manner that the desired electromagnetic effect can be induced or arise. In this case, it is possible, in turn, in a simple manner to select an operating frequency of the first measuring device in such a manner that the desired electromagnetic effect can be induced or arise exclusively or predominantly in the coating of the carrier. In this case, use is made of the fact that depending upon the selected frequency the electromagnetic effect is induced to a different depth in a substance, by way of example in the carrier. The higher the frequency, the less deep the induction effect reaches into the coating or into the carrier. Since the coating material is selected so that the undesirable magnetic effect cannot be induced or cannot arise in the coating to the same extent as in an uncoated carrier, this embodiment of the method—with a skillful choice of frequency—ultimately achieves the avoidance, significant reduction, or compensation of the undesirable magnetic effect.

In a particularly simple manner, a conductive but not ferromagnetic material, chrome or tungsten carbide can be used as a coating or coating component. These are common coating materials that on the one hand are very robust and on the other hand do not exhibit the magnetic effect, or exhibit it to a lesser extent than conventional carrier materials.

With regard to the implementation of a further physical measuring principle, a measuring device in the form of a temperature measuring device can also be used. A temperature value determined using such a measuring device can be used in a simple manner to increase the accuracy of a measured value when measuring a physical variable of the planar medium.

In a further advantageous manner, the sensor can be designed to detect a rotation or part of a rotation of a rotatable carrier for the medium by means of at least two of the implemented measuring devices. Such detection can be automated in a particularly advantageous manner. A repeating profile of the rotatable carrier, for example a roller, can be used for this purpose. The sensor can be arranged in a constant axial position, i.e. without any traversing movement relative to the carrier. This allows the carrier, for example a roller, to be characterized without the use of an encoder.

In this context, and also in principle, detection can be carried out in a particularly simple and reliable manner on the basis of singularities of the carrier and/or a distance between singularities of the carrier. Such singularities or individual characteristics, irregularities or unevenness, for example defects or manufacturing errors, of the carrier can lead to significant signal shapes that in any case are dependent on the angle of rotation, for example peaks, sequences of peaks, etc. in the signal.

In a specific exemplary embodiment, the planar medium can comprise a strip material or a film. Such a medium is used in various, particularly industrial, areas, and its exact properties, especially geometric properties such as thickness or density, are of great importance.

In specific applications, the physical variable can be the thickness or density of the medium. These variables are of great importance in film production, for example, in order to ensure uniform thickness or density of a medium present in the form of a film.

In order to achieve on the one hand a particularly safe and on the other hand particularly simple measurement of the physical variable, the sensor and/or the at least two different measuring devices of the sensor can be designed in such a manner that the measurement of the physical variable can be carried out from only one side of the planar medium. Such a one-sided measurement is particularly advantageous in confined spaces, since in so doing a measuring setup usually does not require as much space as a two-sided measurement.

In an advantageous manner, at least a section of the carrier can be measured with regard to the magnetic effect by means of appropriate measuring means before measuring the physical variable of the medium, and a measurement result recorded by means of the measuring means can be used before, after, and/or during a measurement of the physical variable of the medium to compensate for or reduce the influence of the magnetic effect on the measurement. This enables a particularly reliable measurement of the physical variable. In the best case, an entire surface of the carrier is measured, or at least the part of the surface that carries the medium or on which the medium is placed during a measurement. Based on the measurement result obtained in this manner or the measured values determined in this manner, compensation or reduction of the influence of the magnetic effect on the measurement can be carried out, whereby the measurement result or the measured values can be used before, after, and/or during a measurement of the physical variable of the medium. This enables a particularly reliable and simple measurement of the physical variable.

With respect to a particularly reliable measurement of the physical variable, the measuring means can determine by means of a capacitive and inductive measurement from a measuring position a distance between the measuring means or a definable starting point and the carrier along the section or along the entire surface of the carrier, whereby a difference between a distance value recorded with the capacitive measurement and a distance value recorded with the inductive measurement can be determined at at least one defined or at all measuring locations in the section or on the surface. Depending on the local properties of the carrier, a location-dependent difference signal between the capacitive and inductive measurements is obtained. This difference or difference signal can be determined for the entire surface of the carrier or for a relevant section of the surface.

A relevant section of the surface can be a section which carries the medium or on which the medium is placed. As a result, the magnetic effect can be reduced or compensated.

In a further advantageous manner, the section or the entire surface of the carrier can each be measured at different temperatures. This allows any possible temperature dependence of the measurement result to be compensated or reduced.

For convenience and to ensure particularly reliable measurement of the physical variable, the recorded measurement results, the recorded distance values, and/or the determined difference or differences can be stored in a characteristic map. This allows the carrier to be characterized using a multidimensional characteristic map, which enables active compensation or reduction of the magnetic effect during measurement, even at different temperatures.

Consequently, the sensor in accordance with the invention and method in accordance with the invention provide a sensor and a method that enable a particularly reliable measurement of the physical variable of a planar material using simple design means.

An exemplary embodiment of the sensor in accordance with the invention can be realized as a combination sensor with a high-frequency eddy current sensor—a combination system for conductive media.

Furthermore, in the case of exemplary embodiments of the sensor in accordance with the invention and methods in accordance with the invention, a run-out effect based on Weiß domains can be taken into account.

In the case of exemplary embodiments of the present invention, it is possible to select for the inductive or eddy current measurement an operating frequency f of the sensor so that the inductive or eddy current effect (=measurement effect) occurs in a very thin layer D≈3*δ on the surface of the roller. This can greatly reduce the volume effect on the measurement signal. In principle, the operating frequency (oscillator frequency) of the sensor is increased so that the penetration depth into the roller material or carrier material is so small that the inductive or eddy current effect only occurs in a thin layer immediately at the surface. Interference in the measurement signal from greater depths can thus no longer occur, or can only occur to a greatly reduced extent.

This is particularly advantageous if the carrier or roller, which is usually made of (ferromagnetic) steel for strength reasons, is coated with a homogeneous surface layer of another electrically conductive material. In this case, the measurement signal is essentially influenced by the properties of the layer and not by the underlying roller material. It is particularly advantageous if the surface layer consists of conductive but non-ferromagnetic material, as this eliminates the magnetic effects (Weiß domains!) in the surface layer. If the oscillator frequency of the sensor is appropriately selected, the electromagnetic effect or measurement effect occurs predominantly or exclusively in the surface layer.

A first sensor is usually an inductive or eddy current sensor, and a second sensor can be a capacitive sensor or an optical distance sensor (triangulation, also laser triangulation, laser profile sensor, confocal chromatic sensor, interferometer, etc.), or a profile sensor that detects the height of the strip material on the carrier or roller by shadowing.

In addition to the possible interference effects and their treatment in the context of exemplary embodiments of the present invention, the following is also stated: interference effects, which include not only the magnetic effects due to the Weiß domains already discussed, but also electrical effects due to (micro) cracks that influence the eddy currents, initially occur in the material of the carrier or, for example, a roller, and have a negative influence on the measurement. The aim is to suppress these interference effects. This is achieved by increasing the operating frequency of the eddy current sensor. As a result, the measurement effects only occur in a thin layer on the surface of the carrier or roller (reduced penetration depth). However, this also means that interference effects are reduced because the influence from the depth of the material is reduced. It is also advantageous to apply a non-ferromagnetic coating to the carrier or roller. It is particularly advantageous if the frequency is adapted to the coating or vice versa, so that the measurement effect occurs predominantly or exclusively in the coating. In the case of a non-ferromagnetic coating, magnetic interference effects are then eliminated and interference from micro-cracks is also reduced if the coating material is selected appropriately.

With regard to further advantageous designs of the sensor in accordance with the invention and methods in accordance with the invention, reference is made to the general part of the description and to the appended claims in order to avoid repetition.

Finally, it should be expressly noted that the exemplary embodiments described above serve only to discuss the claimed doctrine and do not limit it to the embodiments.

1. A sensor for measuring a physical variable of a planar medium on a carrier (5), wherein the sensor has two different measuring devices (2, 3) for performing measurements based on at least two different physical measuring principles, wherein the first measuring device (2) has an inductive or eddy current sensor and the second measuring device (3) has a capacitive or optical sensor, wherein the first measuring device (2) is influenced predominantly or exclusively by an electromagnetic effect which can be induced or arise in the carrier (5) of the planar medium during the measurement, and the second measuring device (3) is influenced predominantly or exclusively by the planar medium, wherein the measurement signal of the second measuring device (3), with regard to the measurement signal of the first measuring device (2), yields the measurement signal of the physical variable of the planar medium, and wherein the first measuring device (2) is selected and/or can be operated in such a manner that the electromagnetic effect can be induced or arise exclusively or predominantly in a thinnest possible definable layer on one surface of the carrier (5).

2. The sensor as claimed in claim 1, wherein an operating frequency of the first measuring device (2) can be selected in such a manner that the electromagnetic effect can be induced or arise exclusively or predominantly in the thinnest possible definable layer on the surface of the carrier (5).

3. The sensor as claimed in claim 1, wherein the layer is formed by coating the carrier (5) in such a manner that the electromagnetic effect can be induced or arise.

4. The sensor as claimed in claim 3, wherein an operating frequency of the first measuring device (2) can be selected in such a manner that the electromagnetic effect can be induced or arise exclusively or predominantly in the coating of the carrier.

5. The sensor as claimed in claim 3, wherein a conductive but not ferromagnetic material, chrome or tungsten carbide is used as a coating or coating component.

6. The sensor as claimed in claim 1, wherein, in order to implement a further physical measuring principle, a measuring device in the form of a temperature measuring device (4) is used.

7. The sensor as claimed in claim 1, wherein the sensor is designed to detect a rotation or part of a rotation of a rotatable carrier (5) for the medium by means of at least two of the implemented measuring devices (2, 3, 4).

8. The sensor as claimed in claim 7, wherein detection can be carried out on the basis of singularities of the carrier (5) and/or a distance between singularities of the carrier (5).

9. The sensor as claimed in claim 1, wherein the planar medium has or is a strip material or a film.

10. The sensor as claimed in claim 1, wherein the thickness or the density of the medium can be measured as a physical variable.

11. A method for measuring a physical variable of a planar medium on a carrier (5) with a sensor as claimed in claim 1, wherein the sensor has two different measuring devices (2, 3) for performing measurements based on at least two different physical measuring principles, wherein the first measuring device (2) has an inductive or eddy current sensor and the second measuring device (3) has a capacitive or optical sensor, wherein the first measuring device (2) is influenced predominantly or exclusively by an electromagnetic effect which can be induced or arise in the carrier (5) of the planar medium during the measurement, and the second measuring device (3) is influenced predominantly or exclusively by the planar medium, wherein the measurement signal of the second measuring device (3), with regard to the measurement signal of the first measuring device (2), yields the measurement signal of the physical variable of the planar medium, and wherein the first measuring device (2) is selected and/or is operated in such a manner that the electromagnetic effect can be induced or arise exclusively or predominantly in a thinnest possible definable layer on one surface of the carrier (5).

12. The method as claimed in claim 11, wherein the sensor and/or at least two different measuring devices (2, 3) of the sensor are designed in such a manner that the measurement of the physical variable can be carried out from only one side of the planar medium.

13. The method as claimed in claim 11, wherein at least a section of the carrier (5) is measured with regard to the magnetic effect by means of appropriate measuring means before measuring the physical variable of the medium, and that a measurement result recorded by means of the measuring means can be used before, after, and/or during a measurement of the physical variable of the medium to compensate for or reduce the influence of the magnetic effect on the measurement.

14. The method as claimed in claim 13, wherein the measuring means determines by means of a capacitive and inductive measurement from a measuring position a distance between the measuring means or a definable starting point and the carrier (5) along the section or along the entire surface of the carrier (5), whereby a difference between a distance value recorded with the capacitive measurement and a distance value recorded with the inductive measurement is determined at at least one defined or at all measuring locations in the section or on the surface.

15. The method as claimed in claim 13, wherein the section or the entire surface of the carrier (5) is measured in each case at different temperatures and/or that the recorded measurement results, the recorded distance values, and/or the determined difference or differences are stored in a characteristic map.
